(19) United States
(12) Patent Application Publication
(10) Pub. No.: US 2005/0062243 A1
(43) Pub. Date: Mar. 24, 2005

(54) Toddler walking aid system and device

(76) Inventors: Julie L. Austin, Southfield, MI (US); Brett F. Austin, Southfield, MI (US)

Correspondence Address: Steven Thrasher, 391 Sandhill Dr., Richardson, TX, 75080, US

(21) Appl. No.: 10/668,090

(22) Filed: Sep. 19, 2003

(51) Int. Cl. B62B 1/00

(52) U.S. Cl. 280/35

(57) ABSTRACT

The invention is a toddler walking aid system and device for assisting a toddler to practice walking in a public location. In one embodiment, the system comprises a supporting member that is a foam-coated rod adapted to removably attach to a pipe of a stroller via a screw. In an alternative embodiment, the device comprises a supporting member that is a flute-like pipe that may be locked and stowed on an outer portion of a stroller pipe. In yet another embodiment, the system comprises a supporting member that may be extended and collapsed via telescoping sections.

### TECHNICAL FIELD

The invention relates to walking aids, and, more particularly, the invention relates to toddler walking aids.

### STATEMENT OF A PROBLEM ADDRESSED BY THIS INVENTION

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Statement of a Problem Addressed by This Invention is to be construed as prior art

### DISCUSSION

Strollers are used by adults to carry a toddler through a public location. Commonly, strollers are used because a toddler has not developed walking skills. Walking aids are used to assist toddlers develop their walking skills. Walking aids help support the weight of a newly walking toddler assisting them with balance and coordination.

At times, a toddler will want to practice walking when at a public location, such as a mall, park, or grocery store, for example. Unfortunately, adults do not bring both a stroller and a toddler walking aid to a public location because carrying both items is cumbersome. In addition, a toddler will become upset and in more severe instances will become discourage from learning to walk when at public location.

### SELECTED OVERVIEW OF SELECTED EMBODIMENTS

This invention provides technical advantages as a toddler walking aid system and device allowing a toddler to practice walking in a public location utilizing a walking aid this adapted to removably attach to a stroller, thereby eliminating the need for an adult to bring both a stroller and a toddler walking aid to a public location. In addition, by providing a walking aid that removably attaches to a stroller, a toddler will develop their walking skills more quickly. Preferably, the walking aid is adapted to attach to a side portion of a stroller and support a toddler learning to walk.

In one embodiment, the walking aid is a system comprising a stroller portion, a supporting member, a fastening means, and a coupling means. The supporting member is enabled to assist a toddler walk along the side of the stroller. The supporting member is coupled to the fastening means via the coupling means and the fastening means is adapted to removably attach to the stroller portion.

In another embodiment, the walking aid is a device comprising a supporting member having a top portion and a hollow flute-like bottom portion. Preferably, the bottom portion having a cavity, a fastening means, and a coupling means. When stowed, the bottom portion is removably attached to the supporting member of a stroller portion, such as a pipe, pole, or rod, for example.

In yet another embodiment, the walking aid is a system comprising a stroller portion, a telescoping supporting member having at least two sections one adapted to pass within the other, a securing means, and a locking means. Furthermore, the walking aid system comprises a fastening means and a coupling means. When stowed, the telescoping supporting member is condensed and stored within a stroller portion, such as a pipe, for example. The securing means prevents the supporting member from becoming elongating. When fully extended, the locking means locks the telescoping supporting member such that is locked in its most extended state.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. Accordingly, the invention should be read as being limited only by the claims.

### BRIEF DESCRIPTION OF THE DRAWINGS

Various aspects of the invention, as well as at least one embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 illustrates a toddler walking aid system;

FIG. 2 illustrates a stowable toddler walking aid device; and

FIG. 3 illustrates a telescoping toddler walking aid system.

### AN EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section.

Discussion of the Figures

The invention can be characterized as a toddler walking aid system and device for assisting a toddler to practice walking in a public location. In one embodiment, the system comprises a supporting member that is a foam-coated rod adapted to removably attach to a pipe of a stroller via a screw. In an alternative embodiment, the device comprises a supporting member that is a flute-like pipe that may be locked and stowed on an outer portion of a stroller pipe. In yet another embodiment, the system comprises a supporting member that may be extended and collapsed via telescoping sections.

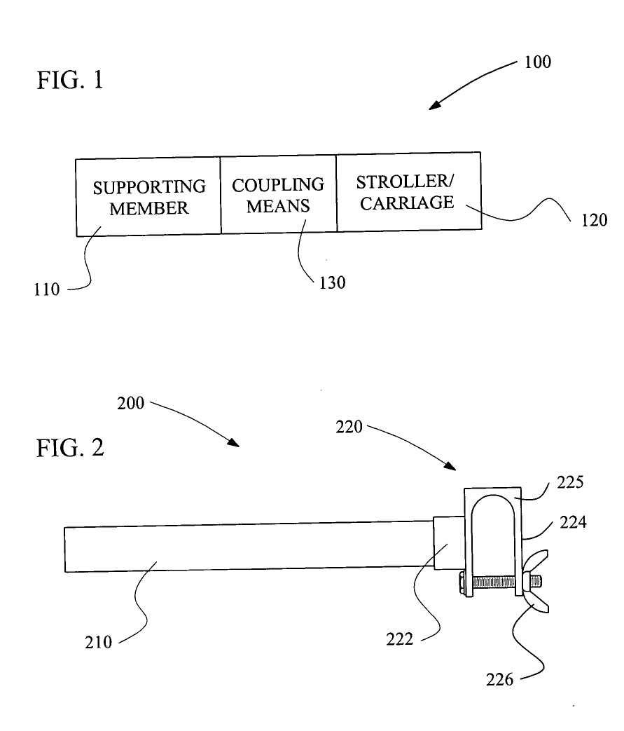

Features and advantages of the invention can be better understood by reviewing FIG. 1, which illustrates a toddler walking aid system 100. The walking aid system 100 comprises a stroller portion 110, a supporting member 120, a coupling means 130, and a fastening means 140. In a preferred embodiment, the walking aid system 100 is a foam-coated pipe that is coupled to a clip that is attached to a side portion of a stroller pipe. In an alternative embodiment, the walking aid system is a foam-coated rod that is coupled to a bracket that is attached to a stroller armrest. In yet another alternative embodiment, the walking aid system 100 is a rigid foam tube that is coupled to a clip that is attached to a leg of a stroller.

The stroller portion 110 may be any portion of a stroller such as a pipe, an armrest, a leg, a canopy, or handle, for example. Stroller portions 110 may comprise metal, plastic, or wood, for example. In some instances, stroller portions 110, may be removably attachable. In other instances, stroller portions 110 are integrally formed within a stroller body.

The supporting member 120 is any solid or hollow member, such as a pipe, rod, shaft, or stick, for example. In a preferred embodiment, the supporting member 120 is coated with a soft material, such as foam, rubber, or cork, for example that forms a grip. The grip may have indentations, ridges, or raised shapes, such as animals, toys, or geometric shapes, for example, for assisting a toddler 105 to hold on to the supporting member 120 with one's hands.

The supporting member 120 may have a length of at least 11 inches and no greater than 24 inches. In addition, the supporting member 120 may be mounted to a stroller portion 110 such that it has a height of at least 15 inches and no greater than 24 inches from the bottom most stroller portion 110. Furthermore, the supporting member 120 may have a diameter of at least one half of an inch and no greater than 2 inches, such that a toddler 105 may wrap one's hands around the supporting member 120.

The coupling means 130 is any means that couples the supporting member 110 to the fastening means 140. In a preferred embodiment, the coupling means 130 may be a rigid joint. In an alternative embodiment, the coupling means 130 may be a flexible joint that has a memory and that may be articulated into a plurality of positions.

The fastening means 140 is any means that secures the supporting member 120 to a stroller portion 110, such as a clamp, bracket, clip, or screw, for example. In a preferred embodiment, the fastening means 140 is a screw that is coupled to one side of the supporting member 120 and is screwed into a threaded hole in the side of a stroller pipe. In an alternative embodiment, the fastening means 140 is a molded plastic clip that snaps on to a stroller armrest. In yet another embodiment, the fastening means 140 is a u shaped bracket that is clipped onto a stroller pipe and tightened via a thumbscrew.

FIG. 2 illustrates a stowable toddler walking aid device 200. In a preferred embodiment, the walking aid device or attachment consists of a supporting member 210 that is generally flute-like in shape comprising a top portion 212 coated with a foam-like grip and a hollow bottom portion 214 having a half-moon shaped cavity. In addition, the fastening means 240 is a screw that is removably attached (via screwing) to a stroller pipe 220 and the coupling means 230 is a rigid plastic joint. Preferably, when attached, the supporting member 210 fastening means 240 is screwed into a threaded hole 222 in a stroller portion 220. Furthermore, when the walking aid 200 is stowed, the fastening means 240 is detached (via unscrewing) from the stroller pipe and the supporting member 210 bottom portion 214 is snapped onto a stroller portion 210.

In an alternative embodiment, the coupling means 230 is a flexible joint that has a memory and that may be articulated into a plurality of positions such that when the walking aid 205 is stowed, the fastening means 240 is fastening to a stroller portion 220 and the supporting means 210 bottom portion 214 cavity is snapped onto a stroller portion 210, such as a pipe, for example. Alternatively, the same functionality may be accomplished by a flexible fastening means 240, such as a hinge, for example.

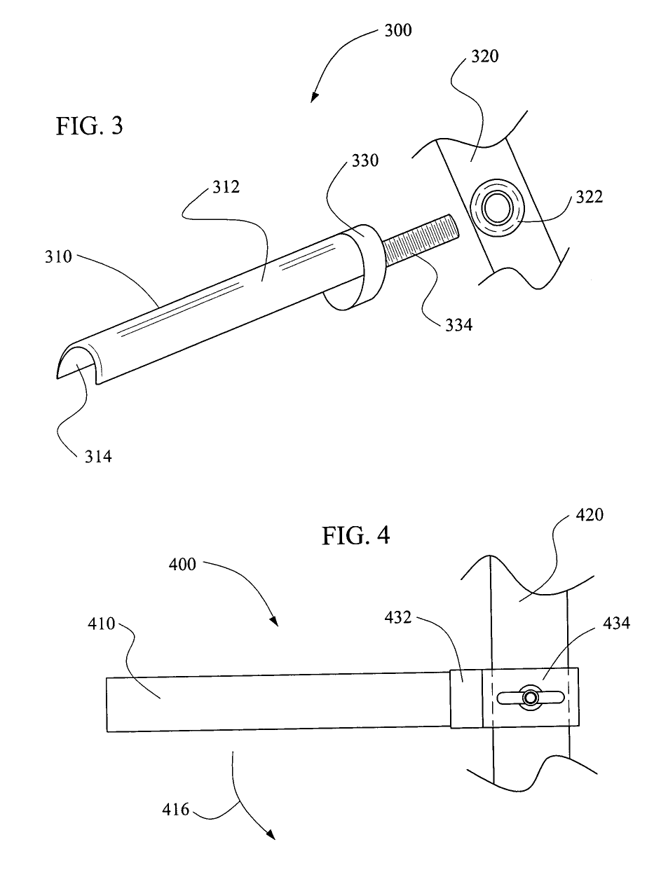

FIG. 3 illustrates a telescoping toddler walking aid system 300. The walking aid system and device comprise a supporting member 310 having at least two generally cylindrical sections 312 adapted to pass one within the other.

In a preferred embodiment, the walking aid system 300 comprises a telescoping supporting member 310 that when fully condensed may stow within a hollow stroller portion 320 such as a pipe, for example. In addition, the telescoping supporting member 310 may have a securing means 312, such as a screw cap, for example, to keep the condensed telescoping supporting member 310 safely stowed within the hollow stroller portion 320. Furthermore, the supporting member 310 may have a locking means 314, such as a peg or pin, for example, keeping the telescoping supporting member 310 locked in its fully elongated state.

Of course, it would be readily apparent to those of ordinary skill in the art that alternative embodiments may include embodying a telescoping walking aid system as a device such as an attachment, for example, whereby the telescoping supporting member may be removably attached via a fastening means, such as a clip, u-shaped bracket and thumb screw, or screw, to a stroller portion, such as a pipe, armrest, or handle, for example. In addition, stowing the toddler walking aid attachment may also be accomplished by securing it to a stroller portion via a strip of Velcro, string, or adhesive, for example. Furthermore, it is also apparent that the walking aid attachment may be made of different materials, or in different dimensions other than those described.

Thus, though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

1. A toddler walking aid system for assisting a toddler to develop motor skills, comprising:
a stroller portion;
a supporting member;
a fastening means adapted to attach the supporting member to the stroller portion; and
a coupling means adapted to couple the supporting member to the fastening means.

2. The walking aid system of claim 1 whereby the stroller portion is a pipe.

3. The walking aid system of claim 1 whereby the stroller portion is an armrest.

4. The walking aid system of claim 1 whereby the stroller portion is a leg.

5. The walking aid system of claim 1 whereby the stroller portion is a handle.

6. The walking aid system of claim 1 whereby the supporting member is a generally hollow pipe.

7. The walking aid system of claim 1 whereby the supporting member is a generally solid rod.

8. The walking aid system of claim 1 whereby the fastening means is removably attached to the stroller portion.

9. The walking aid system of claim 1 whereby the fastening means is integrally formed within the stroller portion.

10. The walking aid system of claim 1 whereby the fastening means is a hinge.

11. The walking aid system of claim 1 whereby the fastening means is a clip.

12. The walking aid system of claim 1 whereby the supporting member is coated with a foam-like polymer.

13. The walking aid system of claim 12 whereby the foam-like polymer is adapted to form a grip suitable for toddler size hands.

14. The walking aid system of claim 1 whereby the coupling means is a joint.

15. The walking aid system of claim 14 whereby the joint may be articulated in a plurality of positions.

16. The walking aid of system claim 1 whereby the supporting member length is less than 24 inches and greater than 11 inches.

17. The walking aid system of claim 1 whereby the supporting member diameter is less than two inches and greater than one half of an inch.

18. The walking aid system of claim 1 whereby the supporting member is attached to a stroller portion such that it has a height of at least 11 inches and no greater than 24 inches from the bottom most stroller portion.

19. A toddler walking aid device for assisting a toddler to develop motor skills, comprising:
a generally flute shaped supporting member comprising a top and a hollow bottom having a cavity, the bottom adapted to secure the supporting member to a stroller portion when in stowed state;
a fastening means adapted to attach the supporting member to the stroller portion; and
a coupling means adapted to couple the supporting member to the fastening means.

20. A toddler walking aid system for assisting a toddler to develop motor skills, comprising:
a stroller portion;
a telescoping supporting member having at least two sections adapted to pass one within the other;
a securing means adapted to secure the supporting member when fully condensed within the stroller portion; and
a locking means adapted to lock the supporting member when fully extended.
